(19) United States
(12) Patent Application Publication
(10) Pub. No.: US 2007/0252304 A1
(43) Pub. Date: Nov. 1, 2007

(54) Method for making multi-layer preform

(75) Inventors: Garrett Pennington, Loganville, PA (US); Pat O'Connell, Hershey, PA (US); Gregory Taylor, York, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: Graham Packaging Company L.P., York, PA (US)

(21) Appl. No.: 11/410,888

(22) Filed: Apr. 26, 2006

(51) Int. Cl. B29C 49/22; B29C 49/02; B29C 49/18

(52) U.S. Cl. 264/234; 264/534; 264/529; 264/235; 264/512; 425/535; 425/522

(57) ABSTRACT

A method for making a multi-layer plastic preform employs blow molding air into the multi-layer parison until an outer layer of the multi-layer parison rests against the preform mold and thereafter inserting a compression core sized to fit the pre-blown preform to smooth the inner layer of the blown parison and finish the preform. A system for making a multi-layer plastic preform includes a blow stem assembly having a device for introducing air into a multi-layer parison captured by a preform mold in a blow-mold operation, and a compression preform core attached to an end of a compression rod wherein when the compression preform core is retracted into the device, air can be blown into the preform mold and when, the compression rod extends in a stroke through the device, the compression preform core extends out of the device into the preform mold.

### BACKGROUND OF THE INVENTION

1. Field of the Invention

The present invention relates generally to an apparatus and method for making a multi-layer, plastic preform that can be utilized in the stretch-blow molding process. More particularly, the invention relates to such a method and apparatus that utilizes standard machine equipment to produce a compression quality multi- or mono-layer, plastic preform.

2. Related Art

In the manufacture of plastic containers, such as monolayer or multilayer PET containers, it is conventional to mold a container preform having a body and a finish with one or more external threads. The finish is typically molded to its final geometry, while the body of the preform is subsequently blow molded to the desired geometry of the container body. Although this manufacturing technique is satisfactory for fabrication of mono-layer plastic containers, the throughput quality of the process is greatly reduced when employed for fabricating multi-layer, plastic preforms and containers. For example, a preform formed by compression or injection molding involves expensive machine and mold costs due to the complex molds with moving parts that are required to form threads of the finish. In addition, multi-layer capability is limited with compression molding as the multi-layer plastic smears disrupting the orientation of the layers as the preform parison is compressed against the plastic. That is, in a compression formed multi-layer preform, the multi-layers of the parison are smeared, resulting in an inner layer being moved to an outer layer, as the pressure of the compression mold moves the layers of the multi-layer plastic.

The other conventional process for forming thermoplastic articles is blow molding, which employs air blowing plastic against a mold instead of a physical body compressing the plastic. However, performs formed by air-blowing tubular parisons are problematic as the distribution of the preform wall thickness is inconsistent. For example, in a multi-layer preform, the orientation of the layers are important after the air-blowing process. Since the outer layer of the multi-layer parison is pressed against a mold, the outer layer remains in its original orientation an outer layer of the resultant preform 2, as the pressure of the compression mold or preform core moves the layers of the multi-layer parison. The disturbed orientation of the layers is shown in FIGS. 1A and 1B.

The other conventional process for forming thermoplastic articles is blow molding, which employs air blowing plastic against a mold instead of a physical body compressing the plastic parison. However, preforms formed by air-blowing tubular parisons are problematic as the distribution of the preform wall thickness is inconsistent. For example, in a multi-layer preform, the orientation of the layers are important after the air-blowing process. Since the outer layer of the multi-layer parison is pressed against a mold, the outer layer remains in its original orientation with respect to the other layers of the parison in the blow molding process. As FIGS. 1A and 1B illustrate, the compression molding process does not necessarily result in the outer layer remaining in its original orientation. The end of the resultant preform 2 has material that was originally in the outer position facing the inside of the preform 2, as shown in FIG. 1A. Thus, the orientation of the layer structure is disturbed and does not result in the layer structure designed for a particular product.

In addition, during a blow-molding operation, the inner layers of the multi-layer parison are blown against the mold and, as a result, some areas of the resultant preform are thicker than other areas. This is due to many factors, but mostly because of the flow head that makes the parison tube. When plastic is forced into the flow head, it flows around various passages to form the hollow tube. During this process, the plastic is subjected to various pressures and temperatures. These pressures and temperatures have a big affect on the plastic's flow characteristics (viscosity). As this plastic exits the flowhead, it is stretchable at different rates when subjected to air in the blow molding process thereby resulting in pools of thicker plastic which is adjacent to thinner plastic areas. Consequently, when a preform 2′ is blow molded into a container or other article 7, as illustrated in FIG. 2, the inconsistent thickness may rupture resulting in a hole 9. For obvious reasons, a container 9 with a hole is not acceptable. In addition to the rupturing problem, blow molding may form areas that are too thick resulting in cooling problems of the resultant container and/or a container that is not pleasing to the eye.

What is needed then is a method of forming preforms that balances the above two processes to form a preform with a consistent thickness and without disrupting the orientation of the layers. In addition, an system that utilizes existing equipment and thus, is less expensive than the specialized molds associated with injection molding is needed.

### BRIEF SUMMARY OF THE INVENTION

In summary, the method and system according to the invention involves a two-step process where an extruded tubular parison is initially air-blown against the preform mold forming a preform with walls disposed against the mold, and thereafter, a preform core is inserted into the air-blown preform with walls to even out the thickness of the walls or smooth the walls thereby finish the resultant preform made from a multi-layer parison.

This invention succeeds where previous efforts have failed because it combines the cost-saving advantages obtained with blow molding with an inexpensive compression molding technique to improve the finishing of multi-layer preform.

This invention is in a crowded and mature art.

This invention differs from the prior art in modifications which were not previously known or suggested.

The invention is achieved with a method of making a multi-layer plastic preform that includes the steps of generating a multi-layer parison with at least an inner layer and an outer layer, capturing the multi-layer parison within a preform mold, blowing sufficient air within the parison so that the outer layer of the parison makes contact with the preform mold, while the orientation of the multi-layer parison is not disrupted, thereby forming a preform shape having walls and thereafter, inserting a core within the blow-molded preform shape and compressing the inner layer walls of blow-molded preform shape thereby finishing the inside of the preform.

A system for making a multi-layer plastic preform according to the invention may be achieved with an extruder (or extruders), which generates (generate) a multi-layer plastic parison, a preform mold that has at least one section that captures a multi-layer parison, and a blow stem assembly that has a device which introduces air into a multi-layer parison captured by the preform mold in a blow-mold operation, a compression rod movably attached adjacent to the device, and a compression preform core attached to an end of the compression rod wherein when the compression preform core is retracted into the device, air can be blown into the preform mold and when, the compression rod extends in a stroke through the device, the compression preform core extends out of the device into the preform mold.

Another advantage of the present invention compared to known blow molding processes is that the preform can be made with decreased cooling times. This is because the compression preform core is cooled via water being circulated there through. Thus, the plastic of the formed preform can be cooled both on the inside (core-side) and the outside (mold-side) due to the insertion of the preform core. This results in faster cycle times thereby increasing production.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIGS. 1A and B illustrate the disturbed layer structure of a three-layer preform formed by compression molding;

FIG. 2 depicts, on the right hand side, a multi-layer preform formed by blow molding (no compression) and, on the left hand side, a blown preform subjected to the stretch-blow process;

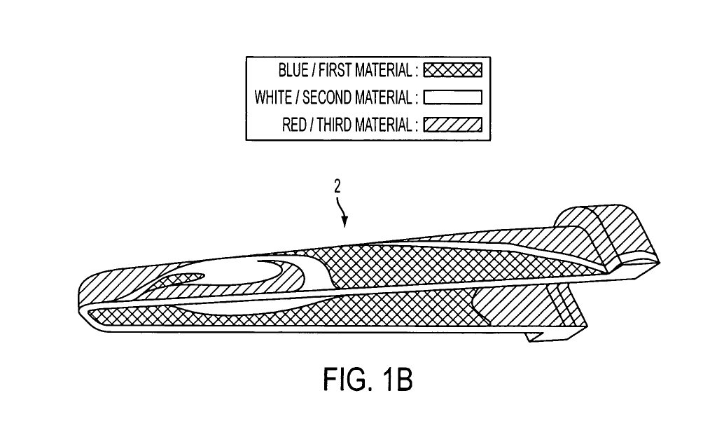

FIG. 3 depicts an exemplary embodiment of a shuttling process according to the present invention;

FIG. 4 shows a multi-layer preform that is pinched together;

FIG. 5 depicts an exemplary embodiment of a modified shuttle machine mold according to the present invention;

FIG. 6 depicts an exemplary embodiment of the compressed blow stem according to the present invention;

FIG. 7 depicts an exemplary embodiment of an exploded blow stem assembly according to the present invention;

FIG. 8 depicts a sectional view of an exemplary embodiment of a mold alignment plate according to the present invention;

FIG. 9 depicts a sectional view of a device of an exemplary embodiment of a device for blowing air according to the present invention;

FIG. 10 depicts a sectional view of an exemplary embodiment of a compression core according to the present invention;

FIG. 11 illustrates a shuttle machine layout with the flow head (die head or extrusion head) extruding a parison on the left side and a two part preform mold with a blow stem assembly located above the preform mold; and

FIG. 12 illustrates a blow stem assembly attached to a conventional shuttle operation.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

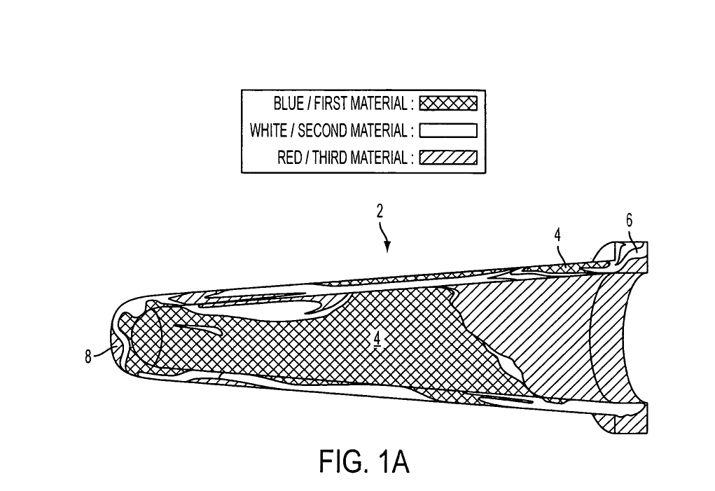

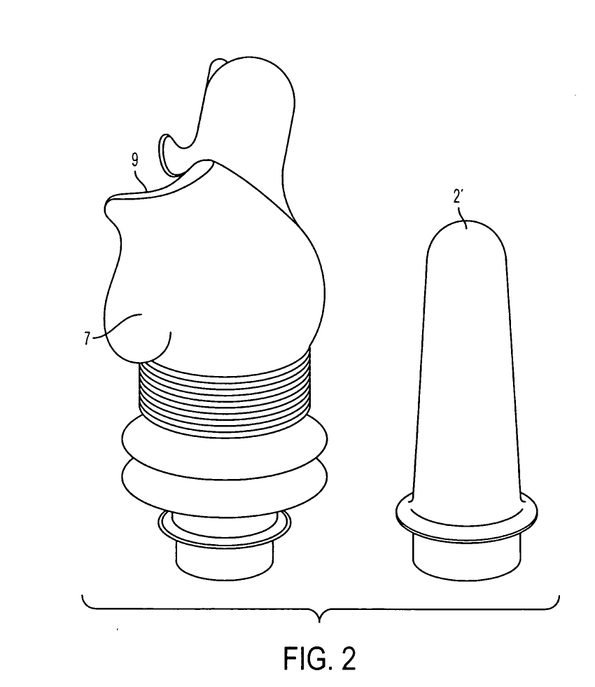

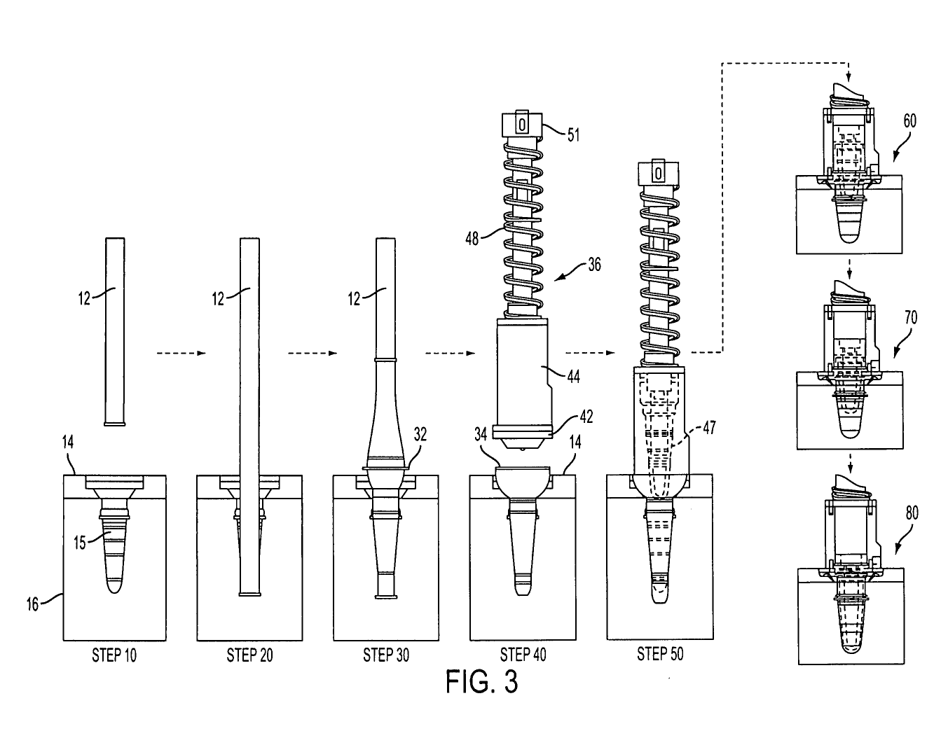

Looking at FIG. 3, a shuttling operation for making a multi-layer plastic preform is shown that moves from the left side of the page to the right side of the page. At the first shuttle step 10, a multi-layer parison 12 is generated above a preform mold 14 with a preform cavity 15. The generated multi-layer parison may have two (2), three (3), or four (4) to six (6) layers of material. In certain applications, more than six layers of material may be desired to form a preform. While a three-layer parison is shown in FIGS. 1A and B, a six layer parison 12′ is shown in FIG. 4 that has been pinched together. Extruded parison that is not used to form the preform is pinched together and removed from the preform mold. This excess material can then be reground and recycled to be used as interior layers of a parison. The reusing of the excess or scrap material saves costs as it is not thrown away.

In an exemplary embodiment, the six barrier layers forming the parison may include an outer layer, which may be a polypropylene layer, a regrind layer, an outer adhesive layer, an EVOH layer, an inner adhesive layer, and an inner layer for contacting food products, which may be a polypropylene layer. To form this layer structure, four extruders would be used: one extruder to supply the inner and outer layers; a second extruder to supply the inner and outer adhesive layers; a third extruder to supply the regrind layer; and a fourth layer to supply the EVOH layer. That is, four extruders could be used to form a six-layer parison. The exemplary embodiment of FIG. 4 shows that the thickness of each layer may vary. For example, the outside material forms 20% of the parison, 65% of the parison material is regrinded material, 5% of the parison is a layer of EVOH and adhesive on either side, and the inside layer or contact material forms 10% of the parison. Since the percentage of the adhesive and EVOH layers is so small, it is the orientation of these layers that can easily be disrupted during conventional compression molding. As a result, the barrier layer arrangement that serves a particular purpose becomes skewed resulting in stretch-blow molded containers with areas where the EVOH barrier layer is missing. In that the EVOH barrier layer may be as thin as one-thousandth of an inch ( 1/1000) in a preform formed from a multi-layer parison, the barrier properties of the EVOH layer may be lost during the stretch blow-molding process. It will be readily understood to those skilled in the art that other larger (thicker layers) can be similarly formulated and manufactured.

Preform mold 14 may have an opening (not shown in FIG. 3) in communication with preform cavity 15 at bottom 16 of preform mold 14 in which excess parison may be released. The preform mold 14 may be constructed of two parts so that it can open to receive the parison 12 within preform cavity 15 and then close about the parison 12 as shown in step 20. That is, the preform mold 14 captures the parison 12 so that the mold surrounds the bottom portion of the parison. When the parison 12 is captured by the preform mold 14, the bottom portion of the parison is pinched as shown in FIG. 4. The pinched portion of the parison is trimmed when the resultant preform is released. Alternatively, the preform mold may have sharp edges that trim the excess parison when it is pinched as the preform mold closes. The excess parison could then be released through an opening (not shown) at the bottom 16 of the preform mold 14.

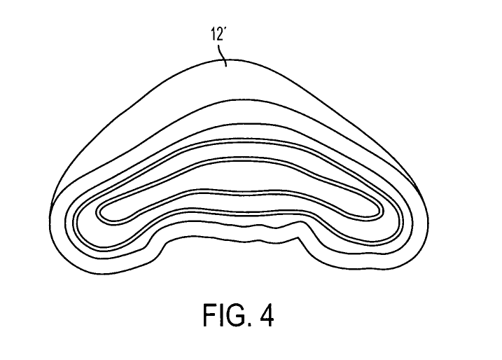

An alternative shuttle machine mold 22 is illustrated in FIG. 5 of the drawings. Shuttle machine mold 22 has at least two parts 23, 24 that open to receive the parison, and remain shut during the combination of blow molding followed by compression molding to finish the preform. Shuttle mold 22 has two preform cavities 25, 26 and a flash pocket area 27 into which excess parison may be released during the compression step. An extruder (or extruders) would form a parison the total length of shuttle mold 22 with two preform cavities 25, 26. Shuttle mold 22 would capture the parison and would form two performs. The flash pocket area 27 compresses parison between the two preform cavities 25, 26 and this flash can be trimmed during a secondary operation. A blow stem assembly, such as a modified blow nozzle with a preform core 28, 29, would be positioned to face each preform mold of shuttle machine mold 22. A modified blow nozzle with a preform core 28, 29 is shown that may be inserted into a respective preform cavity 25, 26.

After the capturing step 20, air may be pre-blown in the parison 12 to activate inflation of the parison within the mold (step 30) before the actual blowing step that forms an unfinished preform. A hot knife 32 cuts the parison as shown in step 30. Then, either the extruded parison 12 or the preform mold 14 with the cut parison 34 is moved so that a blow stem assembly 36 can be positioned above the preform mold 14 with the cut parison 34, as shown in step 40. That is, the preform mold 14 can be indexed to a location underneath the blow stem assembly 36, or the blow stem assembly can be moved to a location above the preform mold 14. In a preferred embodiment, the preform mold 14 would be indexed from one location in its open position, move to surround extruded parison 12, and then close to capture the parison within the preform mold. Then, the preform mold 14 would be indexed back to its original location underneath a blow stem assembly. The upper diameter of the cut parison 34 may be pre-blown and cut so that its diameter has a one to one correspondence with the inner diameter of mold alignment plate 42 of the blow stem assembly 36. The blow stem assembly 36 is lowered to the perform mold 14 so that mold alignment plate 42 comes into contact with the cut parison 34 and pinches the parison to the preform mold 14. Then, air is activated though the blow stem assembly to blow into cut parison 34.

In a preferred embodiment, the plastic of the multi-layer preform is polypropylene (PP). PP material is less expensive when compared with polyethylene terephthalate (PET) material. An acceptable PP container with the desired barrier properties (achieved with PET blown containers) has not been produced with known technology. If the polypropylene preform formed by the inventive method is used in a stretch-blow molding process to form a container or an article, a soft package feel is achieved as compared to the hard plastic of a polyethylene terephthalate (PET) preform. In addition, the orientation of the polypropylene preform has clear, optical quality when properly processed. In order to generate a clear container (obtain molecular orientation of the plastic), the preform is heated to a critical temperature and then stretched. The combination of stretching and heating will cause molecules of the plastic to stretch and align resulting in a clear container. Thus, with the present invention, PP containers with the desired barrier technology can be produced and, as a result, a low cost PP container can be produced that can replace the more expensive PET containers. While a multi-layer preform may be formed of two or more layers, the preferred amount of layers is six; however, the number of layers depends upon the preform being formed and its use. Thus, a multi-layer container may be made from a preform with less than six (6) layers or more than six (6) layers.

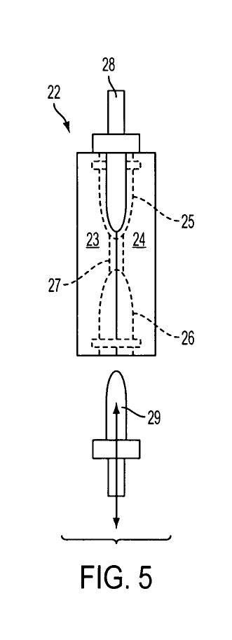

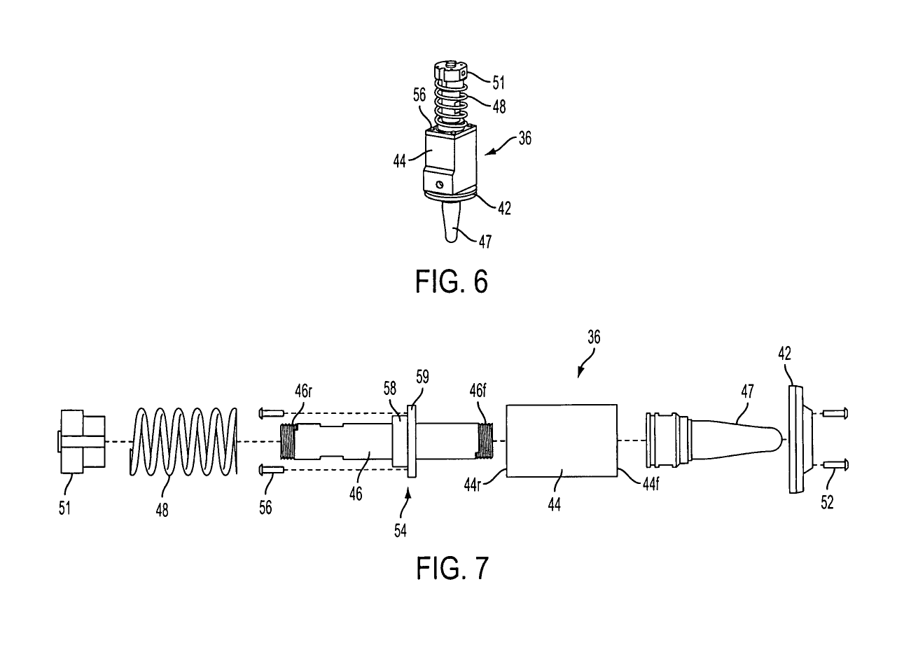

As shown in FIGS. 6 and 7, blow stem assembly 36 is formed of several components. These components include, but are not limited to, mold alignment plate 42, a device for blowing air 44, a compression rod 46, a compression preform core 47, means for activating the compression rod, which may be an air cylinder or a compression spring 48, and a mounting plate adapter 51. In the preferred embodiment, mold alignment plate 42 is attached to the front end 44f of the air blowing device 44 via screws 52. On the other side or rear end 44r of the air blowing device 44, compression rod 46 is movably attached to the device 44. The movable attachment of compression rod 46 to air blowing device 44 may be achieved with an alignment plate 54 that is mounted to the rear end 44r of the air blowing device via screws 56. Alignment plate 54 has a central opening through which compression rod 46 passes and a circumferential flange 58 that extends from a plate 59 of a shape corresponding to the rear end 44r of the air blowing device 44. Consequently, alignment plate 54 guides the stroke of compression rod 46 as the compression rod moves through device 44.

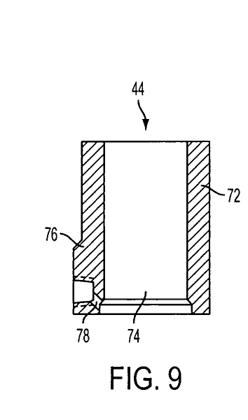

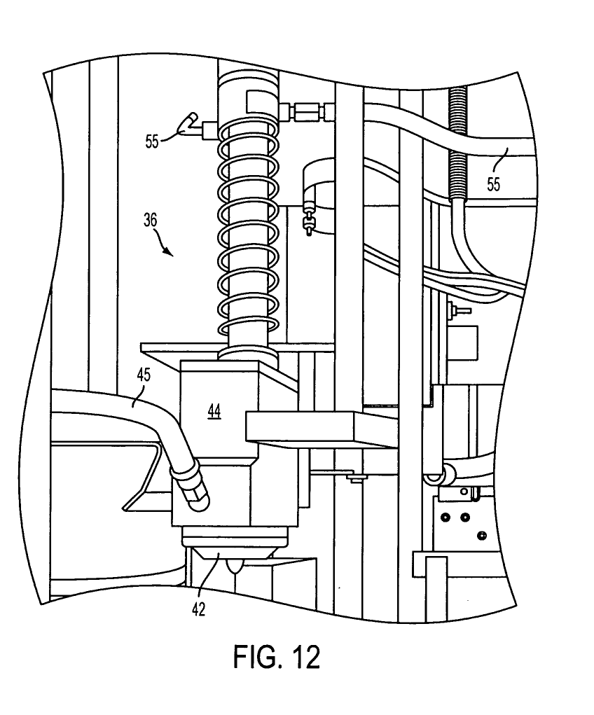

Compression preform core 47, in the exemplary embodiment, is attached to the front end 46f of compression rod via screw threads. The rear end 46r of compression rod is screwed into mounting plate adapter 51 and compression spring 48 surrounds compression rod 46 between alignment plate 54 and mounting plate adapter 51. As shown in step 50 of FIG. 3, the compression preform core 47 is disposed within the air blowing device when compression spring 48 is relaxed. During step 50, mold alignment plate 42 is positioned on the upper diameter of cut parison 34 so that the blow stem assembly is truly centered on the cut parison 34. Then, air is introduced into the cut parison 34 via air blowing device 44 (see FIGS. 9 and 12). The compression preform core 47 is designed so that air can circulate around the preform core and out the inner circumference of the mold alignment plate 42.

By using the air blowing process to form the preform shape, the multi-layer walls of the preform are moved against the preform mold 14. In particular, the outer wall is moved against the preform mold without disrupting the orientation of the multi-layers. This is achieved in that air introduced from air blowing device 44 provides multi-axial pressure that acts normal to the multi-layer parison. Consequently, the cut parison is caused to move against the preform mold in a manner that does not disrupt the orientation of the multi-layer parison. Thus, when a sufficient amount of air is blown within the parison, the parison is expanded to contact the walls of the preform mold 14 thereby forming a preform shape having walls. Since the amount of air is intended to open up parison 34 so that compression preform core 47 can be inserted in to the parison, air needs to activated for less than approximately one (1) second compared to approximately 20 plus seconds for a typical blow molding operation. As discussed above, this preform shape formed by introducing air for approximately less than one second is not complete because blow molding may cause areas of thicker plastic adjacent areas with thinner plastic. That is, preform achieved by the shortened blow-molding process needs the thickness of the inner layer to be smoothed out over the inner portion of the preform so that the preform has a consistent thickness throughout.

Known blow molding operations introduce blow air for the entire duration of the cooling process, in addition to the time for blowing the parison to the sides of the mold. The cooling times are generally greater than approximately 20 seconds. The air pressure during the cooling stage forces the plastic against the outside of the mold to promote cooling of the plastic (via heat transfer from the plastic to the cooled mold) and to maintain the desired package shape. The present invention inserts a compression preform core 47 that forces the plastic of the preform against the outside mold thereby maintaining the desired preform shape. The preform core 47 has means to circulate coolant there through. Thus, the present invention eliminates the need for air to be blown throughout the cooling process thereby resulting in cycle times that are decreased substantially. This is because heat transfer via conduction (cooled core or cooled mold absorbing heat from plastic) is more effective then heat transfer via convection between air and the outside of the plastic.

After blowing sufficient air to form a preform shape having walls, the air is deactivated. Then, as shown in steps 60, 70, 80 of FIG. 3, the compression preform core 47 is extended outside the air blowing device 44 into the blow-molded preform to compress the air-blown inner layer of the preform thereby smoothing the inner layer and finishing the inside of the preform. In the exemplary embodiment, the mounting plate adapter 51 and thus the compression rod 46 are pushed down toward the air blowing device 44 so that the compression spring 48 compresses and the compression preform core 47 moves through and extends outside the air blowing device 44 into the blow-molded preform to compress the blow-molded preform. The compression preform core 47 is sized to so that it fits within the blow-molded preform before applying pressure in a unilateral direction (direction of its extension) against the blow-molded preform thereby smoothing the air-blow inner layer while maintaining orientation of the multi-layers of plastic. That is, the compression preform core 47 does not push the blow-molded preform out to the walls of the preform mold, but does force the plastic material against the walls of mold 14 to maintain shape. Consequently, compression preform core 47 does not smear the multi-layer parison as it is inserted into preform mold 14. Instead, the compression core of the invention smooths or “irons” the inner layer, in the appropriate locations, to accurately form a preform with consistent thickness (where desired) and does not disrupt the layer orientation of the multi-layer parison. If any position along the axis of the preform requires a thicker amount or layer of material, the blow-molding process followed by the compression finishing process of the invention would allow the desired increase in thickness. The control process of increasing and decreasing the amount of material is important for the compression process because if too much or too little material is placed in an area, the preform core may move the material during the compression step thereby disrupting layer structure.

As a result of the blow molding process followed by the finishing, compression step, the alignment of the multi-layer parison is maintained and the thickness of preform is consistently formed. As a result, a container formed in a subsequent stretch-blow molding process of the formed preform does not rupture and does not have areas where barrier layers are missing. Step 50 shows the bottom portion of the blown parison with a rounded dotted line. The area beneath the dotted line represents excess parison that can be trimmed off at a later stage.

After the finishing, compression step is achieved, the mold parts 23, 24 may open to release the formed preform from the mold. The finished, preform would remain attached to the compression preform core until the blow stem assembly is retracted thereby removing the finished, resultant preform from compression preform core 47. Alternatively, a robotic arm or other mechanical device may grab the preform.

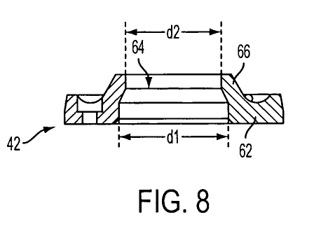

FIG. 8 depicts a sectional view of an exemplary embodiment of a mold alignment plate according to the present invention. In a preferred embodiment the device for blowing air 44 may be a cylinder. The mold alignment plate 42 includes a plate 62 that corresponds to the contour of the device for blowing air 44. Plate 62 has a circumferential opening 64 and an angled flange 66 surrounding the circumferential opening so that the circumferential opening 64 has a first diameter d1 and narrows to a second diameter d2 away from the air blowing device 44. The compression preform core 47 is designed to extend through circumferential opening 62.

FIG. 9 depicts a sectional view of a device of an exemplary embodiment of a device for blowing air according to the present invention. The contour of the device for blowing air 44, as shown in FIG. 6, may be a three-dimensional rectangle. The air blowing device 44 includes a body 72 with a cylindrical opening 74. Cylindrical opening 74 is large enough to receive the widest portion of compression perform core 47. Step 50 shows compression perform core within the cylindrical opening 74. One side of body 72 has a thickened end 76 through which a recess with an angled air opening 78 is drilled or otherwise formed. The diameter of cylindrical opening 74 of device 44 on the end that is attached to mold alignment plate 42 is slightly less than the first diameter d1 of the mold alignment plate 42. Thus, air introduced via angled air opening 78 is delivered to the blow-molded parison. While in this exemplary embodiment, the air opening is angled so that the air is moved in the direction in which circulation is desired, it is not necessary for the opening to be angled as the air will fill the void of the preform mold 14 thereby pushing the parison against a wall of the preform mold. The introduced air acts normal to the parison and pushes the parison against perform mold 14 to form an initial perform. Because the air pushes the layers of the multi-layer parison uniformly (in the same direction normal to the parison), the layers are not smeared or disrupted as in the conventional compressive molding process.

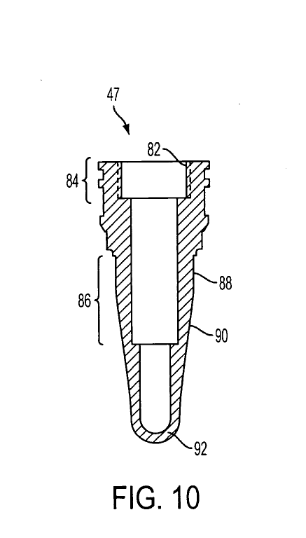

FIG. 10 depicts a sectional view of an exemplary embodiment of compression core 47 according to the present invention. Compression perform core 47 is made of one-piece construction and has a threaded end 82, which is attached to threaded end 46f of compression rod 46. In a preferred embodiment, perform core 47 has a first end 84, which surrounds threaded end 82 at one end, an intermediate section 86 including a portion 88 with an angled portion 90, and a curved, second end 92. The outside diameter of the first end is larger than the outside diameter of portion 88. The angled portion 90 begins with the diameter of portion 88 and narrows to the largest diameter of the curved, second end 92. That is, preform core 47 narrows at the end adjacent angled air opening 78 when preform core 47 is fully retracted into air blowing device 44.

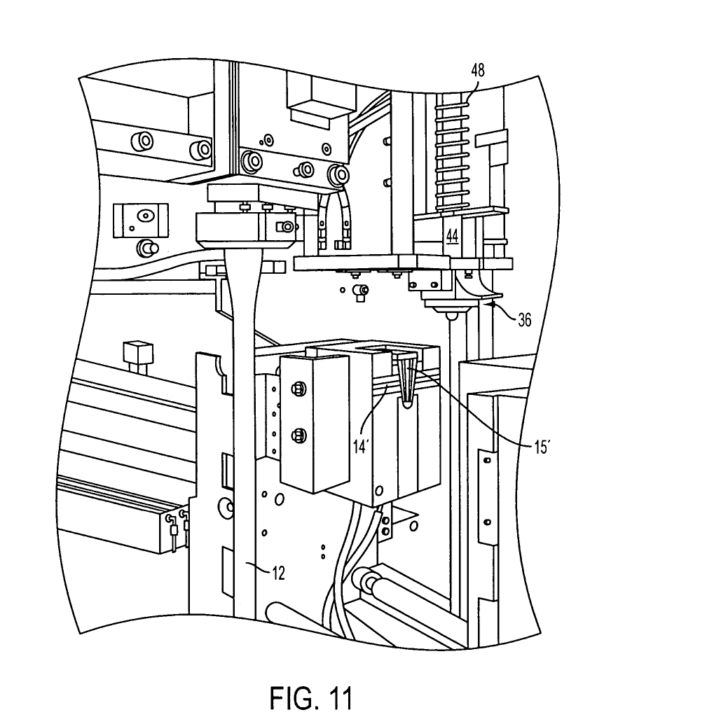

FIG. 11 illustrates a shuttle machine with the flow head extruding the parison 12 on the left-hand side, and the two part preform mold 14′ on the right-hand side of the Figure. The blow stem assembly 36 is mounted over the preform mold 14′. A hose leading into the extended side of device 44 supplies air to the device. The blow stem assembly is mounted to the shuttle machine bolts and other standard equipment used in shuttle machine operations so that the blow stem assembly extends like an arm from above the preform mold 14′. Water hoses 55 are provided at the top of FIG. 12 to supply the blow stem assembly 36 with cooling water. The cooling water is circulated through core 47 so that the plastic can be cooled both on the mold-side and the core-side of the parison.

FIG. 12 illustrates a blow stem assembly attached to a conventional shuttle operation. The blow stem assembly may move so that it will come into contact with the mold and captured parison in step 50. An air hose 45 is connected to opening 78 to supply air to the parison when the blow stem assembly is mold alignment plate 42 closes off the top of the parison.

One point of novelty of the above-described invention is that the blow stem assembly can be easily attached to conventional or standard shuttle machine equipment. For example, the mounting plate adapter 51 can be inexpensively bolted to standard equipment.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. For example, instead of shuttle machine blow molding platform, this invention can be used with continuous blow molding machines, shuttle machines with multiple flow heads that produce multiple parisons, and a tangential extrusion platform. It is therefore to be understood that, within the scope of the claims and their equivalents, the invention may be practiced otherwise than as specifically described.

What is claimed is:

1. A method of making a multi-layer plastic preform comprising the steps of:
generating a multi-layer parison with at least an inner layer and an outer layer;
capturing the parison within a preform mold;
blowing sufficient air within the parison so that the outer layer of the parison makes contact with the preform mold, while the orientation of the multi-layer parison is not disrupted, thereby forming a preform shape having walls; and
thereafter, inserting a core within the blow-molded preform shape and compressing the inner layer walls of blow-molded preform shape thereby finishing the inside of the preform.

2. The method of making a multi-layer plastic preform according to claim 1, further comprising the step of pre-blowing air to activate inflation of the parison within the preform mold before the blowing step.

3. The method of making a multi-layer plastic preform according to claim 1, wherein at least one layer of the plastic is polypropylene.

4. The method of making a multi-layer plastic preform according to claim 1, wherein the blowing step followed by the finishing, compression step maintains the alignment of the multi-layer parison of the preform so that the thickness of a container formed in a stretch-blow molding process is substantially consistent.

5. The method of making a multi-layer plastic preform according to claim 1, wherein the preform mold is formed of two parts and further comprising the step of opening the two parts of the mold after the step of compressing the blow-molded preform.

6. The method of making a multi-layer plastic preform according to claim 1, wherein a two-stage blow stem initially blows air into the parison and then inserts the core within the preform shape.

7. The method of making a multi-layer plastic preform according to claim 1, wherein the step of blowing air within the parison occurs multi-axially and normal to the multi-layer parison so that the parison conforms to the mold without disrupting the orientation of the layer thickness.

8. The method of making a multi-layer plastic preform according to claim 1, wherein the compression step applies the core unilaterally against the blow-molded preform to smooth out the blow-molded inside of the preform while maintaining orientation of the multi-layer plastic.

9. The method of making a multi-layer plastic preform according to claim 1, wherein the multi-layer plastic has six layers.

10. The method of making a multi-layer plastic preform according to claim 6, wherein the two-stage blow stem further includes an alignment plate so that the blow stem is aligned with the mold before the step of blowing air and inserting the core to compress the blow-molded parison against the mold.

11. The method of making a multi-layer plastic preform according to claim 1, further comprising the step of heating the finished preform to a critical temperature point so that the molecular orientation of the plastic produces a clear package after the stretch blow molding process.

12. The method of making a multi-layer plastic preform according to claim 10, further comprising the step of retracting the inserted core of the blow stem in order to remove the resultant preform.

13. A system for making a multi-layer plastic preform, comprising:
at least one extruder generating a multi-layer plastic parison with at least an inner layer and an outer layer;
a parison mold having at least one section that captures a multi-layer parison; and
a blow stem assembly having a device for introducing air into a multi-layer parison captured by the parison mold in a blow-mold operation, a compression rod movably attached adjacent to the device, and a compression preform core attached to an end of the compression rod wherein when the compression preform core is retracted into the device, air can be blown into the preform mold and when, the compression rod extends in a stroke through the device, the compression preform core extends out of the device into the preform mold.

14. The system according to claim 13, wherein the parison mold is part of a shuttling operation and the extruder and blow stem assembly are arranged over a parison mold at an appropriate stage.

15. The system according to claim 13, wherein the blow stem assembly further comprises a mold alignment plate attached to the other side or front of the device.

16. The system according to claim 14, wherein the blow stem assembly bolts onto an attachment of a shuttle machine.

17. The system according to claim 13, wherein there are two preform cavities in a single parison mold.

18. The system according to claim 17, wherein one preform cavity is on one side of the single parison mold and the second preform cavity is on the other side of the single parison mold, and wherein a blow stem assembly is positioned to face both sides of the single parison mold.

19. The system according to claim 13, wherein the blow stem assembly further comprises a preblow alignment plate attached to the rear of the device.

20. The system according to claim 16, wherein the blow stem assembly further comprises a mounting plate adapter that is attached to the end of the compression rod opposite the end attached to the device wherein the mounting plate adapter attaches the blow stem assembly to a shuttle machine.
